(19) United States
(12) Patent Application Publication
(10) Pub. No.: US 2020/0356231 A1
(43) Pub. Date: Nov. 12, 2020

(54) TOUCH SENSOR AND METHOD FOR MANUFACTURING THE SAME, DISPLAY PANEL AND METHOD FOR MANUFACTURING THE SAME AND DISPLAY DEVICE

(71) Applicants: HEFEI XINSHENG OPTOELECTRONICS TECHNOLOGY CO., LTD., Hefei, Anhui (CN); BOE TECHNOLOGY GROUP CO., LTD., Beijing (CN)

(72) Inventors: Xianlin DING, Beijing (CN); Ming ZHANG, Beijing (CN); Qicheng CHEN, Beijing (CN)

(21) Appl. No.: 16/640,543

(22) PCT Filed: Mar. 22, 2019
(86) PCT No.: PCT/CN2019/079293

§ 371 Date: Feb. 20, 2020

(30) Foreign Application Priority Data
Apr. 3, 2018 (CN) 201810288813.3

(51) Int. Cl. G06F 3/041; G06F 3/044

(52) U.S. Cl. CPC G06F 3/04164; G06F 2203/04111; G06F 2203/04103; G06F 3/0446

(57) ABSTRACT

The disclosure provides a touch sensor and a method for manufacturing the same, a display panel and a method for manufacturing the same, and a display device. The method for manufacturing the touch sensor includes: forming a plurality of touch electrode lines on a first substrate motherboard; cutting the first substrate motherboard according to a size of a touch area of a second base substrate to obtain a touch area component; forming a plurality of connecting wires on a peripheral area of the second base substrate to obtain a peripheral area component; and attaching the peripheral area component and the touch area component to each other, so that the connecting wires are electrically coupled to the touch electrode lines in one-to-one correspondence.

### CROSS REFERENCE TO RELATED APPLICATIONS

The present application claims priority to Chinese patent application No. 201810288813.3 fled on Apr. 3, 2018, the content of which is incorporated herein by reference.

### TECHNICAL FIELD

The present disclosure relates to the field of touch technology, and in particular to a touch sensor and a method for manufacturing the same, a display panel and a method for manufacturing the same, and a display device.

### BACKGROUND

A touch display panel has advantages of being convenient to be operated, good in user's experiences and the like, and is increasingly widely applied. In related art, the touch display panel usually adopts an OGS (One Glass Solution), that is, touch sensors are directly manufactured on a protective glass, so that a total thickness of the touch display panel can be correspondingly reduced, a structure of the touch display panel can be simplified, and a weight of the touch display panel can be reduced.

### SUMMARY

An embodiment of the present disclosure provides a method for manufacturing a touch sensor, the method including: forming a plurality of touch electrode lines on a first substrate motherboard; cutting the first substrate motherboard according to a size of a touch area of a second base substrate to obtain a touch area component; forming a plurality of connecting wires in a peripheral area of the second base substrate to obtain a peripheral area component; and attaching the peripheral area component to the touch area component, and electrically coupling the connecting wires to the touch electrode lines in one-to-one correspondence.

In some implementations, electrically coupling the connecting wires to the touch electrode lines in one-to-one correspondence includes: coating a conductive adhesive at positions of the connecting wires of the peripheral area component or at positions of the touch area component corresponding to the connecting wires; and attaching the peripheral area component and the touch area component to each other, so that the connecting wires are electrically coupled to the touch electrode lines in one-to-one correspondence through the conductive adhesive.

In some implementations, the method further includes: before forming the plurality of connecting wires in the peripheral area of the second base substrate, forming a black matrix on the peripheral area of the second base substrate, an orthographic projection of each of the connecting wires on the second base substrate is located within a range of an orthographic projection of the black matrix on the second base substrate.

In some implementations, forming the plurality of touch electrode lines on the first substrate motherboard includes: forming a plurality of first touch electrode lines and a plurality of second touch electrode lines on the first substrate motherboard, the first touch electrode lines and the second touch electrode lines intersect; and forming the plurality of connecting wires in the peripheral area of the second base substrate includes: forming a plurality of first connecting wires and a plurality of second connecting wires in the peripheral area of the second base substrate.

In some implementations, electrically coupling the connecting wires to the touch electrode lines in one-to-one correspondence includes: electrically coupling the first connecting wires to the first touch electrode wires in one-to-one correspondence, and electrically coupling the second connecting wires to the second touch electrode lines in one-to-one correspondence.

An embodiment of the present disclosure provides a method for manufacturing a display panel, including the method for manufacturing the touch sensor.

An embodiment of the present disclosure further provides a touch sensor, including a touch area component and a peripheral area component attached to each other, where the touch area component comprises a first base substrate and a plurality of touch electrode lines formed on the first base substrate, the peripheral area component comprises a second base substrate and a plurality of connecting wires formed on the second base substrate, the touch electrode lines are located in a touch area of the touch sensor, the connecting wires are located in a peripheral area of the touch sensor, and the connecting wires are electrically coupled to the touch electrode lines in one-to-one correspondence.

In some implementations, the connecting wires are electrically coupled to the touch electrode lines in one-to-one correspondence through a conductive adhesive.

In some implementations, each of the connecting wires includes a connection portion and a wiring portion electrically coupled to each other, the connection portion has a width larger than that of the wiring portion, and the connection portion is configured to be electrically coupled to a corresponding one of the touch electrode lines.

In some implementations, the periphery area component further includes a black matrix formed on a side of the connecting wires proximal to the second base substrate, the black matrix is located in the periphery area of the touch sensor, and an orthogonal projection of each of the connecting wires on the second base substrate is located within a range of an orthogonal projection of the black matrix on the second base substrate. In some implementations, the touch electrode lines include a plurality of first touch electrode lines and a plurality of second touch electrode lines, the plurality of first touch electrode lines and the plurality of second touch electrode lines intersect, the connecting wires include a plurality of first connecting wires and a plurality of second connecting wires, the first connecting wires are electrically coupled to the first touch electrode lines in one-to-one correspondence, and the second connecting wires are electrically coupled to the second touch electrode lines in one-to-one correspondence.

In some implementations, the first base substrate is a flexible base substrate and the second base substrate is a rigid base substrate.

An embodiment of the present disclosure provides a display panel, including the touch sensor described above.

An embodiment of the present disclosure provides a display device, including the display panel described above.

### BRIEF DESCRIPTION OF THE DRAWINGS

FIG. 1 is a schematic structural diagram of a first substrate motherboard in an embodiment of the present disclosure;

FIG. 2 is a schematic structural diagram of a periphery area component in an embodiment of the present disclosure;

FIG. 3 is a schematic structural diagram of a touch sensor in an embodiment of the present disclosure;

FIG. 4 is a cross-sectional view of the touch sensor of FIG. 3 taken along line AA′;

FIG. 5 is a flowchart of a method for manufacturing a touch sensor according to an embodiment of the present disclosure.

### DETAILED DESCRIPTION

In order to make those skilled in the art better understand the technical solution of the present disclosure, a method for manufacturing a touch sensor and a touch sensor provided in the present disclosure are described in detail below with reference to the accompanying drawings.

A process for manufacturing the touch sensor on a protective glass in the related art includes: firstly forming a black matrix in a peripheral area of the protective glass, then sequentially forming a horizontal electrode, an insulating layer and a longitudinal electrode in a touch area of the protective glass, and then forming a first connecting wire electrically coupled with the horizontal electrode and a second connecting wire electrically coupled with the longitudinal electrode in an area where the black matrix is located.

The process for manufacturing the touch sensor is complex, so that the manufacturing time is long, and the production capacity is influenced.

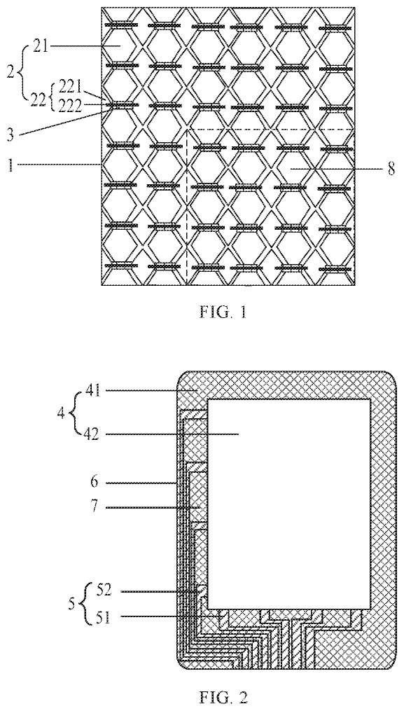

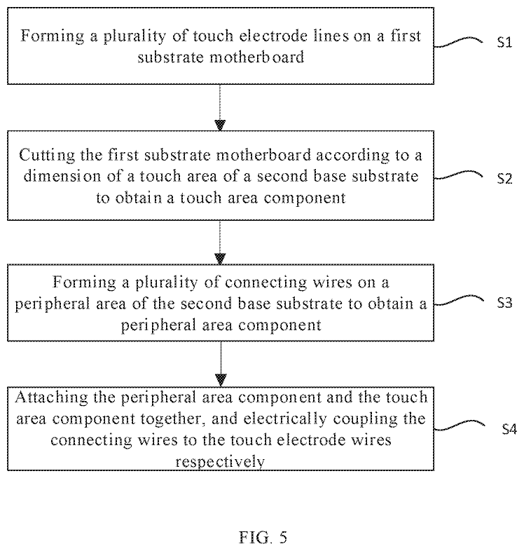

An embodiment of the present disclosure provides a method for manufacturing a touch sensor, and as shown in FIGS. 1 to 5, the method may include steps S1 to S4.

Step S1, forming a plurality of touch electrode lines 2 on a first substrate motherboard 1.

Specifically, as shown in FIG. 1, the plurality of touch electrode lines 2 may be formed on an entire surface of the first substrate motherboard 1 by using a photolithography process or a screen printing process.

In an implementation, the touch electrode lines 2 may be made of indium tin oxide or indium zinc oxide.

As shown in FIG. 1, the touch electrode lines 2 include first touch electrode lines 21 and second touch electrode lines 22, and the first touch electrode lines 21 and the second touch electrode lines 22 intersect.

In the embodiment of the present disclosure, the first touch electrode lines 21 are disposed in parallel along a longitudinal direction, and the second touch electrode lines 22 are disposed in parallel along a horizontal direction. Each of the second touch electrode lines 22 may include a plurality of second touch electrode portions 221 and a plurality of bridging portions 222, each second touch electrode portion 221 in each second touch electrode line 22 is located between two adjacent first touch electrode lines 21, and each bridging portion 222 in each second touch electrode line 22 electrically couples two adjacent second touch electrode portions 221 in the second touch electrode line 22.

Correspondingly, the step (i.e., the step S1) of forming the plurality of touch electrode lines 2 on the first substrate motherboard 1 specifically includes: synchronously forming the plurality of first touch electrode lines 21 and the plurality of second touch electrode portions 221 on the first substrate motherboard 1; forming insulating layers 3 on the first touch electrode line 21 at positions corresponding to the bridging portions 222 to prevent the first touch electrode lines 21 and the second touch electrode lines 22 from being short-circuited; forming the bridging portions 222 at positions where the insulating layers 3 are located. The “synchronously forming” in the present embodiment refers to forming in a same process.

Step S2, cutting the first substrate motherboard 1 according to a dimension of a touch area 42 of a second base substrate 4 to obtain a touch area component 8.

Specifically, as shown in FIG. 1 and FIG. 2, a cutting process (e.g., a knife wheel cutting process or a laser cutting process) may be used to cut the first substrate motherboard 1 according to the dimension shown by the dotted line in FIG. 1, so as to obtain the touch area component 8 corresponding to the dimension of the touch area 42 of the second base substrate 4.

Step S3, forming a plurality of connecting wires 5 on a peripheral area 41 of the second base substrate 4 to obtain a peripheral area component 6.

Specifically, as shown in FIG. 2, the plurality of connection wires 5 may be formed in the peripheral area 41 of the second base substrate 4 by using a photolithography process or a screen printing process.

In some implementations, the material of the connecting wires 5 may be aluminum, copper, or silver.

As shown in FIG. 2, the connecting wires 5 include a plurality of first connecting wires 51 and a plurality of second connecting wires 52.

In the embodiment of the present disclosure, the first connecting wires 51 are configured to be electrically coupled to the first touch electrode lines 21 in the touch area component 8 in one-to-one correspondence, and the second connecting wires 52 are configured to be electrically coupled to the second touch electrode lines 22 in the touch area component 8 in one-to-one correspondence.

In order to cover the connecting wires 5 in the peripheral area 41 of the second base substrate 4, as shown in FIG. 2, before the plurality of connecting wires 5 are formed on the peripheral area 41 of the second base substrate 4, a black matrix 7 is formed in the peripheral area 41 of the second base substrate 4, an orthographic projection of each connecting wire 5 on the second base substrate 4 is within a range of an orthographic projection of the black matrix 7 on the second base substrate 4, so that the connecting wires 5 in the peripheral area 41 can be covered by the black matrix 7.

Step 4, attaching the peripheral area component 6 and the touch area component 8 together, and electrically coupling the connecting wires 5 to the touch electrode lines 2 respectively.

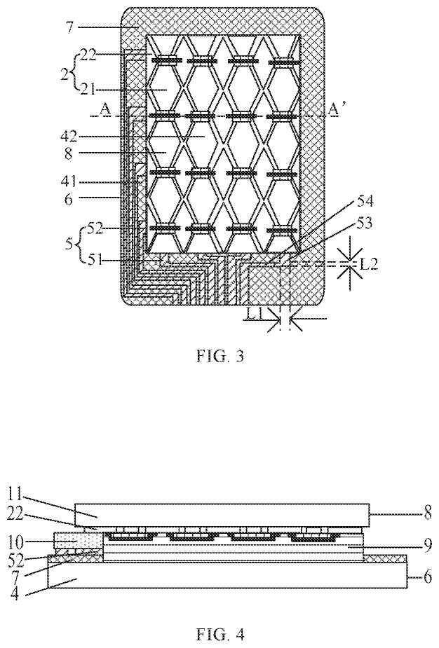

Specifically, as shown in FIG. 3 and FIG. 4, the peripheral area component 6 and the touch area component 8 may be attached by using an optical clear adhesive (OCA) 9, and specifically, two sides of the optical clear adhesive 9 are respectively attached to the peripheral area component 6 and the touch area component 8.

It should be noted that, in order to facilitate electrical connecting between the connecting wires 5 and the touch electrode lines 2 in one-to-one correspondence, a size of the touch area component 8 is larger than a size of the touch area 42 of the second base substrate 4, that is, the touch area component 8 corresponds to both the entire touch area 42 on the second base substrate 4 and a portion of the peripheral area 41 of the second base substrate 4 where the connecting wires 5 are located.

As shown in FIG. 3, electrically coupling the connecting wires 5 to the touch electrode lines 2 in one-to-one correspondence specifically includes: electrically coupling the first connecting wires 51 to the first touch electrode lines 21 in one-to-one correspondence, and electrically coupling the second connecting wires 52 to the second touch electrode lines 22 in one-to-one correspondence.

It should be noted that the first connecting wires 51 and the second connecting wires 52 are further electrically coupled to a driving chip (not shown), and in a touch process, the driving chip may determine the touch position according to change in electrical signals in the first touch electrode lines 21 and the second touch electrode lines 22 respectively detected by the first connecting wires 51 and the second connecting wires 52, and according to the first touch electrode lines 21 and the second touch electrode lines 22 in which the signals change.

In the method for manufacturing the touch sensor according to the embodiment of the present disclosure, the plurality of touch electrode lines 2 are formed on the first substrate motherboard 1, and accordingly, in the process of manufacturing touch sensors with different sizes, the first substrate motherboard 1 is cut according to the size of the touch area 42 of the second base substrate 4 to obtain the touch area component 8, then the plurality of connecting wires 5 are formed on the peripheral area 41 of the second base substrate 4 to obtain the peripheral area component 6, and finally, the peripheral area component 6 and the touch area component 8 are attached to each other, and the connecting wires 5 are electrically coupled to the touch electrode lines 2 in one-to-one correspondence. Since touch area components 8 in the touch sensors with different sizes can be obtained by cutting the first substrate motherboard 1, the touch area components 8 with different sizes do not need to be manufactured respectively in the process of manufacturing the touch sensors with different sizes, the manufacturing process of the touch sensors can be simplified, the manufacturing time can be reduced correspondingly, the production capacity can be increased. In addition, in the process of manufacturing the touch sensors with different sizes, only a mask plate for manufacturing the first substrate motherboard 1 needs to be purchased, mask plates for manufacturing the touch area components 8 with different sizes are not needed to be purchased respectively, so that the cost of manufacturing and development can be reduced.

With reference to FIGS. 3 and 4, electrically coupling the connecting wires 5 to the touch electrode lines 2 in one-to-one correspondence includes: coating a conductive adhesive 10 at positions of the connecting wires 5 of the peripheral area component 6 or at positions of the touch area component 8 corresponding to the connecting wires 5; attaching the peripheral area component 6 and the touch area component 8 to each other, so that the connecting wires 5 are electrically coupled to the touch electrode lines 2 through the conductive adhesive 10.

Specifically, after the conductive adhesive 10 is coated at the positions of the first connecting wires 51 and the second connecting wires 52 of the peripheral area component 6 or at the positions of the touch area component 8 corresponding to the first connecting wires 51 and the second connecting wires 52, a pressing apparatus may be used to press the positions of the first connecting wires 51 and the second connecting wires 52 of the peripheral area component 6 and the positions of the touch area component 8 corresponding to the first connecting wires 51 and the second connecting wires 52, so that the first connecting wires 51 are electrically coupled to the first touch electrode lines 21 in one-to-one correspondence, and the second connecting wires 52 are electrically coupled to the second touch electrode lines 22 in one-to-one correspondence.

In some implementations, the conductive adhesive 10 is made of an anisotropic conductive adhesive, so that the conductive adhesive 10 can ensure that the connecting wires 5 are electrically coupled to the touch electrode lines 2 respectively in a direction perpendicular to the touch area component 8 and the peripheral area component 6, and can prevent any two adjacent connecting wires 5 from being conducted with each other.

Another embodiment of the present disclosure provides a touch sensor, as shown in FIG. 3 and FIG. 4, the touch sensor may include a touch area component 8 and a peripheral area component 6 attached to each other, the touch area component 8 may include a first base substrate 11 and a plurality of touch electrode lines 2 formed on the first base substrate 11, the peripheral area component 6 may include a second base substrate 4 and a plurality of connecting wires 5 formed on the second base substrate 4, the touch electrode lines 2 are located in a touch area 42 of the touch sensor, the connecting wires 5 are located in a peripheral area 41 of the touch sensor, where the connecting wire 5 are electrically coupled to the touch electrode line 2 in one-to-one correspondence.

Specifically, an optically transparent adhesive 9 may be disposed between portions of the touch area component 8 and the peripheral area component 6 corresponding to the touch area 42, and two sides of the optically transparent adhesive 9 are respectively adhered to the touch area component 8 and the peripheral area component 6, so that the touch area component 8 and the peripheral area component 6 are attached to each other.

The touch sensor of the embodiment of the present disclosure includes the touch area component 8 and the peripheral area component 6, where the touch area component 8 includes the first base substrate 11 and the plurality of touch electrode lines 2 formed on the first base substrate 11, the peripheral area component 6 may include the second base substrate 4 and the plurality of connecting wires 5 formed on the second base substrate 4, and the touch area component 8 and the peripheral area component 6 are attached to each other such that the connecting wires 5 are electrically coupled to the corresponding touch electrode line 2 respectively, thereby the touch sensor is formed. Since the touch electrode lines 2 on each of touch area components 8 in touch sensors with different sizes are periodically arranged, a plurality of touch electrode lines 2 can be correspondingly formed on the first substrate motherboard 1, and the touch area components 8 with different sizes can be obtained by cutting the first substrate motherboard 1 in the process of manufacturing the touch sensors with different sizes, so that the manufacturing process of the touch sensors can be simplified, the manufacturing time can be correspondingly reduced, the production capacity can be increased. In addition, in the process of manufacturing the touch sensors with different sizes, only a mask plate for manufacturing the first substrate motherboard 1 is needed to be purchased, mask plates for manufacturing the touch area components 8 with different sizes are not needed to be purchased respectively, and the cost of manufacturing and development can be further reduced.

As shown in FIG. 4, each connecting wire 5 may be electrically coupled to the touch electrode line 2 corresponding to the connecting wire 5 through a conductive adhesive 10. In some implementations, the conductive adhesive 10 is made of an anisotropic conductive adhesive, so that the conductive adhesive 10 can electrically couple the connecting wires 5 and the corresponding touch electrode lines 2 respectively in a direction perpendicular to the touch area component 8 and the peripheral area component 6, and can prevent any two adjacent connecting wires 5 from being conducted with each other.

As shown in FIG. 3 and FIG. 4, the peripheral area component 6 may further include a black matrix 7 formed on a side of the connecting wires 5 proximal to the second base substrate 4, the black matrix 7 is located in the peripheral area 41 of the touch sensor, and an orthographic projection of each connecting wire 5 on the second base substrate 4 is located within a range of an orthographic projection of the black matrix 7 on the second base substrate 4. Thus, the black matrix 7 can cover the connecting wires 5 provided in the peripheral area 41.

As shown in FIG. 3, the touch electrode lines 2 may include a plurality of first touch electrode lines 21 and a plurality of second touch electrode lines 22, and the first touch electrode lines 21 and the second touch electrode lines 22 are arranged in a crossing manner. The connecting wires 5 may include a plurality of first connecting wires 51 and a plurality of second connecting wires 52, the first connecting wires 51 are electrically coupled to the first touch electrode lines 21 in one-to-one correspondence, and the second connecting wires 52 are electrically coupled to the second touch electrode lines 22 in one-to-one correspondence.

Specifically, in the embodiment of the present disclosure, the first touch electrode lines 21 are disposed in parallel along a longitudinal direction, and the second touch electrode lines 22 are disposed in parallel along a horizontal direction. Each of the second touch electrode lines 22 may include a plurality of second touch electrode portions 221 and a plurality of bridging portions 222, each second touch electrode portion 221 of each second touch electrode line 22 is located between two adjacent first touch electrode lines 21, and each bridging portion 222 of each second touch electrode line 22 electrically couples two adjacent second touch electrode portions 221 of the second touch electrode line 22. An insulating layer 3 is further disposed between the first touch electrode lines 21 and the bridging portions 222.

It should be noted that the first connecting wires 51 and the second connecting wires 52 are also electrically coupled to the driving chip, and in the touch process, the driving chip may determine the touch position according to change in electric signals in the first touch electrode lines 21 and the second touch electrode lines 22 respectively detected by the first connecting wires 51 and the second connecting wires 52, and according to the first touch electrode lines 21 and the second touch electrode lines 22 in which the signals change.

As shown in FIG. 3, each of the first connecting wires 51 and the second connecting wires 52 may include a connection portion 53 and a wiring portion 54 coupled to each other, a width L of the connection portion 53 is greater than a width L2 of the wiring portion 54, and each connection portion 53 is electrically coupled to the touch electrode line 2 corresponding thereto. Since the width L1 of the connecting portion 53 is relatively large, the connecting area between the connecting wire 5 and the touch electrode line 2 can be increased accordingly, and thus a contact resistance between the connecting wire 5 and the touch electrode line 2 can be reduced.

In some implementations, the first base substrate 11 is a flexible base substrate, for example, a PET (polyethylene terephthalate) base substrate or a COP (optical material) base substrate, and the second base substrate 4 is a rigid base substrate such as a glass base substrate. Certainly, it is also possible that the first substrate 11 is a rigid base substrate and the second base substrate 4 is a flexible base substrate.

Another embodiment of the present disclosure provides a display panel including the touch sensor in the above embodiments.

Another embodiment of the present disclosure provides a display device including the display panel in the above embodiment.

Another embodiment of the present disclosure provides a manufacturing method of a display panel, including the method of manufacturing the touch sensor in the above embodiments.

It should be understood that the above embodiments are merely exemplary embodiments employed for illustrating the principles of the technical solutions of the present disclosure, and the present disclosure is not limited thereto. It will be apparent to those skilled in the art that various changes and modifications can be made therein without departing from the spirit of the present disclosure, and these changes and modifications should also be construed as falling within the scope of the present disclosure.

1. A method for manufacturing a touch sensor, comprising:
forming a plurality of touch electrode lines on a first substrate motherboard;
cutting the first substrate motherboard according to a size of a touch area of a second base substrate to obtain a touch area component;
forming a plurality of connecting wires in a peripheral area of the second base substrate to obtain a peripheral area component; and
attaching the peripheral area component to the touch area component, and electrically coupling the connecting wires to the touch electrode lines in one-to-one correspondence.

2. The method for manufacturing the touch sensor according to claim 1, wherein electrically coupling the connecting wires to the touch electrode lines in one-to-one correspondence comprises:
coating a conductive adhesive at positions of the connecting wires of the peripheral area component or at positions of the touch area component corresponding to the connecting wires; and
attaching the peripheral area component and the touch area component to each other, so that the connecting wires are electrically coupled to the touch electrode lines in one-to-one correspondence through the conductive adhesive.

3. The method for manufacturing the touch sensor according to claim 1, further comprising:
before forming the plurality of connecting wires in the peripheral area of the second base substrate, forming a black matrix on the peripheral area of the second base substrate,
wherein an orthographic projection of each of the connecting wires on the second base substrate is located within a range of an orthographic projection of the black matrix on the second base substrate.

4. The method for manufacturing the touch sensor according to claim 1, wherein forming the plurality of touch electrode lines on the first substrate motherboard comprises: forming a plurality of first touch electrode lines and a plurality of second touch electrode lines on the first substrate motherboard, wherein the first touch electrode lines and the second touch electrode lines intersect; and
wherein forming the plurality of connecting wires in the peripheral area of the second base substrate comprises: forming a plurality of first connecting wires and a plurality of second connecting wires in the peripheral area of the second base substrate.

5. The method for manufacturing the touch sensor according to claim 4, wherein electrically coupling the connecting wires to the touch electrode lines in one-to-one correspondence comprises:
electrically coupling the first connecting wires to the first touch electrode wires in one-to-one correspondence, and electrically coupling the second connecting wires to the second touch electrode lines in one-to-one correspondence.

6. A method for manufacturing a display panel, comprising the method for manufacturing the touch sensor according to claim 1.

7. A touch sensor, comprising a touch area component and a peripheral area component which are attached to each other, wherein
the touch area component comprises a first base substrate and a plurality of touch electrode lines formed on the first base substrate, the peripheral area component comprises a second base substrate and a plurality of connecting wires formed on the second base substrate, the touch electrode lines are located in a touch area of the touch sensor, the connecting wires are located in a peripheral area of the touch sensor, and the connecting wires are electrically coupled to the touch electrode lines in one-to-one correspondence.

8. The touch sensor according to claim 7, wherein the connecting wires are electrically coupled to the touch electrode lines in one-to-one correspondence through a conductive adhesive.

9. The touch sensor according to claim 7, wherein each of the connecting wires comprises a connection portion and a wiring portion electrically coupled to each other, the connection portion has a width larger than that of the wiring portion, and the connection portion is configured to be electrically coupled to a corresponding one of the touch electrode lines.

10. The touch sensor according to claim 7, wherein the periphery area component further comprises a black matrix formed on a side of the connecting wires proximal to the second base substrate, the black matrix is located in the periphery area of the touch sensor, and an orthogonal projection of each of the connecting wires on the second base substrate is located within a range of an orthogonal projection of the black matrix on the second base substrate.

11. The touch sensor according to claim 7, wherein the touch electrode lines comprise a plurality of first touch electrode lines and a plurality of second touch electrode lines, the plurality of first touch electrode lines and the plurality of second touch electrode lines intersect;
the connecting wires comprise a plurality of first connecting wires and a plurality of second connecting wires, the first connecting wires are electrically coupled to the first touch electrode lines in one-to-one correspondence, and the second connecting wires are electrically coupled to the second touch electrode lines in one-to-one correspondence.

12. The touch sensor according to claim 7, wherein the first base substrate is a flexible base substrate and the second base substrate is a rigid base substrate.

13. A display panel, comprising the touch sensor according to claim 7.

14. A display device, comprising the display panel according to claim 13.

15. The method for manufacturing the touch sensor according to claim 2, further comprising:
before forming the plurality of connecting wires in the peripheral area of the second base substrate, forming a black matrix on the peripheral area of the second base substrate,
wherein an orthographic projection of each of the connecting wires on the second base substrate is located within a range of an orthographic projection of the black matrix on the second base substrate.

16. The method for manufacturing the touch sensor according to claim 2, wherein forming the plurality of touch electrode lines on the first substrate motherboard comprises: forming a plurality of first touch electrode lines and a plurality of second touch electrode lines on the first substrate motherboard, wherein the first touch electrode lines and the second touch electrode lines intersect; and
wherein forming the plurality of connecting wires in the peripheral area of the second base substrate comprises: forming a plurality of first connecting wires and a plurality of second connecting wires in the peripheral area of the second base substrate.

17. The method for manufacturing the touch sensor according to claim 3, wherein forming the plurality of touch electrode lines on the first substrate motherboard comprises: forming a plurality of first touch electrode lines and a plurality of second touch electrode lines on the first substrate motherboard, wherein the first touch electrode lines and the second touch electrode lines intersect; and
wherein forming the plurality of connecting wires in the peripheral area of the second base substrate comprises: forming a plurality of first connecting wires and a plurality of second connecting wires in the peripheral area of the second base substrate.

18. The touch sensor according to claim 8, wherein each of the connecting wires comprises a connection portion and a wiring portion electrically coupled to each other, the connection portion has a width larger than that of the wiring portion, and the connection portion is configured to be electrically coupled to a corresponding one of the touch electrode lines.

19. The touch sensor according to claim 8, wherein the periphery area component further comprises a black matrix formed on a side of the connecting wires proximal to the second base substrate, the black matrix is located in the periphery area of the touch sensor, and an orthogonal projection of each of the connecting wires on the second base substrate is located within a range of an orthogonal projection of the black matrix on the second base substrate.

20. The touch sensor according to claim 8, wherein the touch electrode lines comprise a plurality of first touch electrode lines and a plurality of second touch electrode lines, the plurality of first touch electrode lines and the plurality of second touch electrode lines intersect;
the connecting wires comprise a plurality of first connecting wires and a plurality of second connecting wires, the first connecting wires are electrically coupled to the first touch electrode lines in one-to-one correspondence, and the second connecting wires are electrically coupled to the second touch electrode lines in one-to-one correspondence.
